(19) United States
(12) Patent Application Publication
(10) Pub. No.: US 2015/0134725 A1
(43) Pub. Date: May 14, 2015

(54) COMPUTER-IMPLEMENTED METHODS, COMPUTER READABLE MEDIUM AND SYSTEMS FOR VIRTUAL APPLICATION EXECUTION

(71) Applicant: Adrian Cesena, Jr., Palo Alto, CA (US)

(72) Inventor: Adrian Cesena, Jr., Palo Alto, CA (US)

(21) Appl. No.: 14/079,474

(22) Filed: Nov. 13, 2013

(51) Int. Cl. H04L 29/08; H04L 29/06

(52) U.S. Cl. CPC H04L 67/10; H04L 67/42
USPC 709/203

(57) ABSTRACT

One or more computer devices share remote computer resources. An application program is instantiated on at least one server so as to run a “virtual application” on the server. At least one computer device communicates with the server over a network. A virtual screen, also instantiated on the server, stores screen data corresponding to input data from the computer device and an output data from the virtual application. A UI server is also instantiated on the server. The UI server receives the input data from the computer device, for subsequent input to the virtual application, and transmits the screen data from the virtual screen to the computer device. Under this configuration, the computer device may utilize the resources of the server by effectively running the application on the server.

### BACKGROUND OF THE INVENTION

1. Field of the Invention

The present invention is related to the field of computing, and more specifically to techniques to “remote” applications over a network.

2. Art Background

The Internet has become an essential medium for business and media. Although use of the Internet in modern society is essentially ubiquitous, one potential area of future expansion in the Internet is the ability for users to share online experiences. Sharing online experiences, such as visiting websites, is one way for users to have a social experience on the Internet. These shared online experiences often take the form of co-browsing. In general, co-browsing is joint navigation of websites by multiple people that access web pages at the same time. Some current techniques for co-browsing require special software at the client and/or co-browsing enabled websites. Since users may only co-browse on web sites that are co-browsing enabled, this technology limits the users to only a small subset of Internet sites. As a consequence, it is desirable to create a co-browsing system that does not require special plug-ins or co-browsing enabled websites so as to permit users to co-browse at any website.

### SUMMARY OF THE INVENTION

A computer-implemented method, computer readable medium and system allow one or more computer devices to share remote computer resources. An application program is instantiated on at least one server so as to run a “virtual application” on the server. At least one computer device communicates with the server over a network. A virtual screen, also instantiated on the server, stores screen data corresponding to input data from the computer device and an output data from the virtual application. A UI server is also instantiated on the server. The UI server receives the input data from the computer device, for subsequent input to the virtual application, and transmits the screen data from the virtual screen to the computer device. Under this configuration, the computer device may utilize the resources of the server by effectively running the application on the server.

In some embodiments, the computer device may comprise a mobile computing device (e.g., mobile phone, tablet computer, etc.). In the same or other embodiments, the computer device may comprise a plurality of computer devices. Under this embodiment, the computer devices may co-use the virtual application such that the UI server collects keystrokes, clicks and cursor position from multiple computer devices for input to the virtual application. In addition, the virtual screen is replicated so as to allow the computer devices to co-use the application.

A computer-implemented method, computer readable medium and system permit co-browsing of one or more websites between at least two users. In some embodiments, a virtual browser, instantiated on at least one server, is configured to interact with a plurality of websites. The virtual browse receives, from a first computer device, a first input data that specifies a request to enter a session at one of the websites and receives, from a second computer device, a second input data for the session at the Website. The virtual browser generates one or more requests to the website based on the first and second input data. The virtual browser receives, in response to the request to the website, response data from the website. The server transmits from to the first and second computer devices the response data from the website.

### BRIEF DESCRIPTION OF THE DRAWINGS

The novel features of the invention are set forth in the appended claims. However, for purpose of explanation, several embodiments of the invention are set forth in the following figures.

FIG. 1 is a block diagram illustrating a system to permit computers to remotely share computing resources.

FIG. 2 is a block diagram illustrating one embodiment for a computer architecture to support remote operation of applications for use by one or more computing devices.

FIG. 3 is a flow diagram illustrating one embodiment to initiate a session among multiple users to co-use a software application.

FIG. 4 is a flow diagram illustrating one embodiment for a process for multiple users to co-use an application program.

FIG. 5 is a block diagram illustrating one embodiment for implementing Internet co-browsing among multiple users.

FIG. 6 is a flow diagram illustrating one embodiment for initiating a co-browsing session.

FIG. 7 is a flow diagram illustrating one embodiment for a co-browsing process.

FIG. 8 is a block diagram illustrating a use case scenario for Internet co-browsing and co-using of applications.

FIG. 9 is a block diagram illustrating co-browsing with multiple co-browser instantiations at the virtual server.

FIG. 10 is a diagrammatic representation of a network and a computer system.

### DETAILED DESCRIPTION

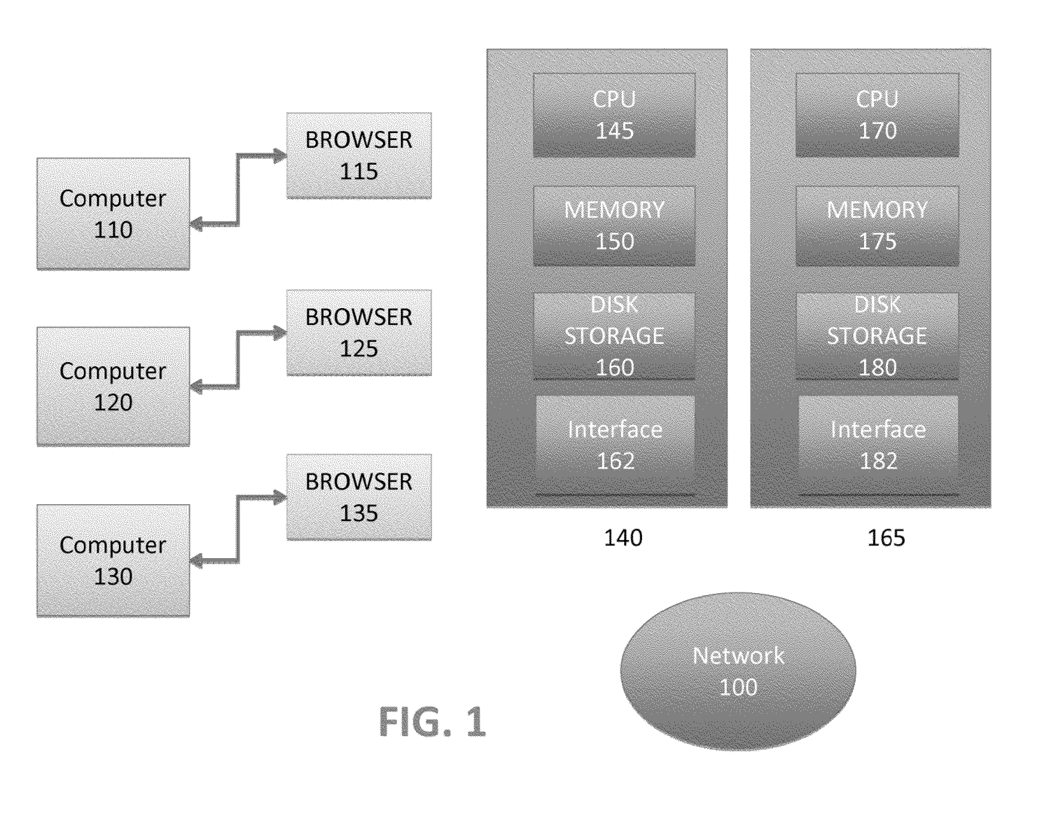

FIG. 1 is a block diagram illustrating a system to permit computers to remotely share computing resources. As shown in FIG. 1, computers 110, 120 and 130 access, through network 100, resources on computer (e.g., servers) 140 and 165. Computer servers 140 and 165 include computing resources, such as CPUs (145 and 170), memory (150 and 175) and disk storage (160 and 180). Servers 140 and 165 may be high-end servers with multiple processors, large amounts of memory, and large disk arrays. Conversely, computers 110, 120 and 130 may be computing devices of limited resources, such as mobile devices, tablet devices, or laptop computers. In general, computers 110, 120 and 130 access the servers (140 and 165) to utilize the CPU, memory and disk storage resources. For example, the computers 110, 120 and 130 may interface with servers 140 and 165 to remotely execute application programs that require CPU, memory and disk storage resources. For example, computers 110, 120 and 130 may utilize computer resources on servers 140 and 165 to execute enterprise applications and to browse Internet websites. Embodiments for co-use of applications and co-browsing of Internet Websites by multiple computers are described more fully below.

For the example of FIG. 1, computers 110, 120 and 130 may use computer resources of servers 140 and 165, thereby using only a minimum amount of local computer resources. To this end, computers 110, 120 and 130 operate Internet browsers (115, 125 and 135, respectively). The computers may run any type of Internet browser, such as commercially available browsers Google Chrome, Mozilla Firefox, Microsoft Explorer, etc. In order to provide computer resources, servers 140 and 165 include interface 162 and 182, respectively. Interface 162 and 182 permit communication (exchange of data) between computers (110, 120 and 130) and servers (140 and 165) by using only a browser. To this end, interface 162 and 182 formats all requests and responses between computers (110, 120 and 130) and servers (140 and 165) to the hypertext transfer protocol (HTTP). To accomplish this, interface (162 and 182) converts input/output from the applications running on the server to an HTTP format. Computers 110, 120 and 130 only consume a minimum amount of resources to operate their browsers while utilizing computing resources of servers 140 and 165 to execute software.

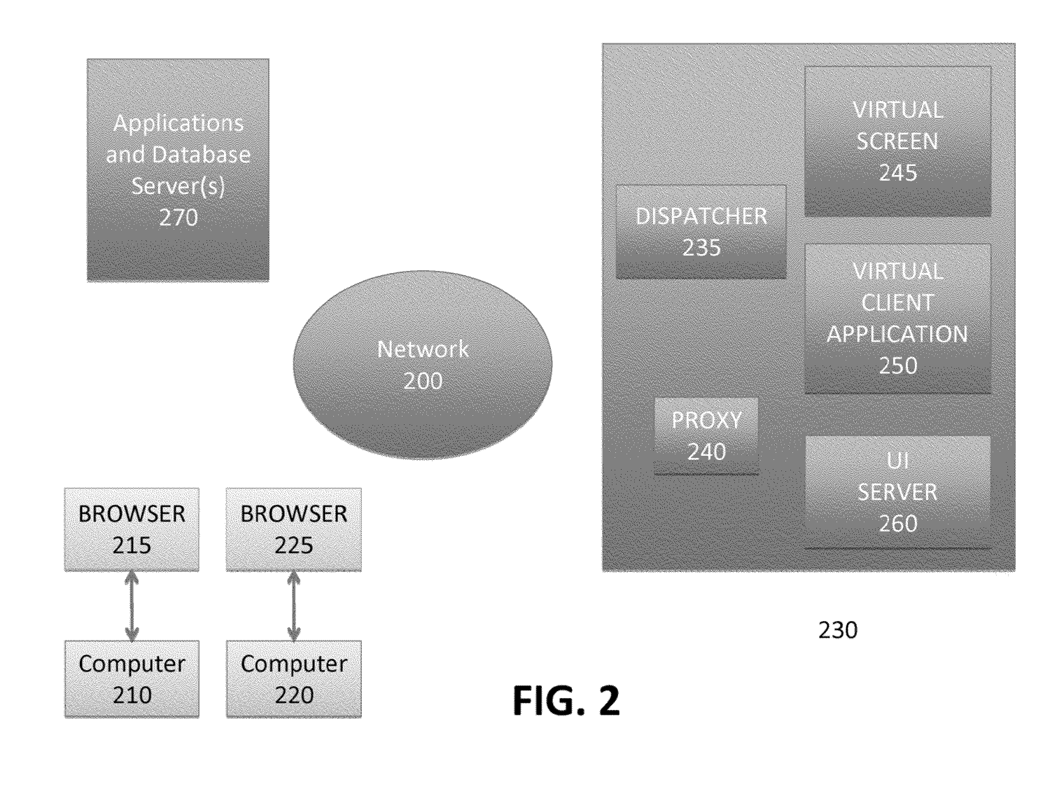

FIG. 2 is a block diagram illustrating one embodiment for a computer architecture to support remote operation of applications for use by one or more computing devices. For this example, software applications, such as enterprise applications, may run on one or more servers. As used herein, an application connotes any software application program that provides functionality. In some embodiments, the applications comprise enterprise applications. As used herein, an enterprise application may include any type of application software that typically runs in an enterprise software environment, including accounting software, customer resource management (CRM) software, enterprise resource planning (ERP) software, etc. For the example of FIG. 2, servers that operate applications, including database servers, are depicted as Applications and Database Server(s) 270. A virtual server 230, which may be implemented on one or more computers, operates to remote the application for computers 210 and 220. Applications and Database Servers 270, virtual server 230 and computers 210 and 220 are all accessible through network 200 (e.g., wide area network).

For this example, computers 210 and 220 desire to share use of an application program (e.g., enterprise application) running on Applications and Database Server(s) 270. As such, computers 210 and 220 “co-use” the enterprise application (i.e., both computers interact with an applications program in a collaborative environment). In some embodiments, the application may run in a client-server environment. For the example of FIG. 2, the server portion of the application program runs on Applications and Database Servers 270, while the client portion runs on virtual server 230 for the benefit of computers 210 and 220.

For this embodiment, the virtual server 230, which may operate on one or more computers, comprises several subcomponents to facilitate the remote operation of the application for the benefit of computers 210 and 220. Specifically, for this embodiment, virtual server 230 includes dispatcher 235. As is explained more fully below, dispatcher 235 initiates a session for multiple users to run enterprise software by instantiating batch processes associated with the session. For this embodiment, the batch processes include virtual screen 245, virtual client application 250 and user interface (UI) server 260. In general, virtual screen 245 stores screen data of the application for viewing on computers 210 and 220. The virtual client application 250 runs the client portion of the application and supplies screen data to virtual screen 245. UI server 260 monitors input data from computers 210 and 220 and updates input to virtual screen 245 and virtual client application 250, as appropriate. Proxy 240 operates to connect computers 210 and 220 to the batch processes (i.e., virtual screen 245, virtual client application 250 and UI server 260) instantiated by dispatcher 235.

In operation, virtual client application 250 transmits input data to the server portion of the application (running on Applications and Database Server(s) 270). In turn, the application, running on Applications and Database Server(s) 270, outputs data, including screen data, to virtual client application 250 in a manner typical for operation in a client-server environment. Virtual server 230 transmits screen data to, and receives input data from, computers 210 and 220 via an Internet protocol.

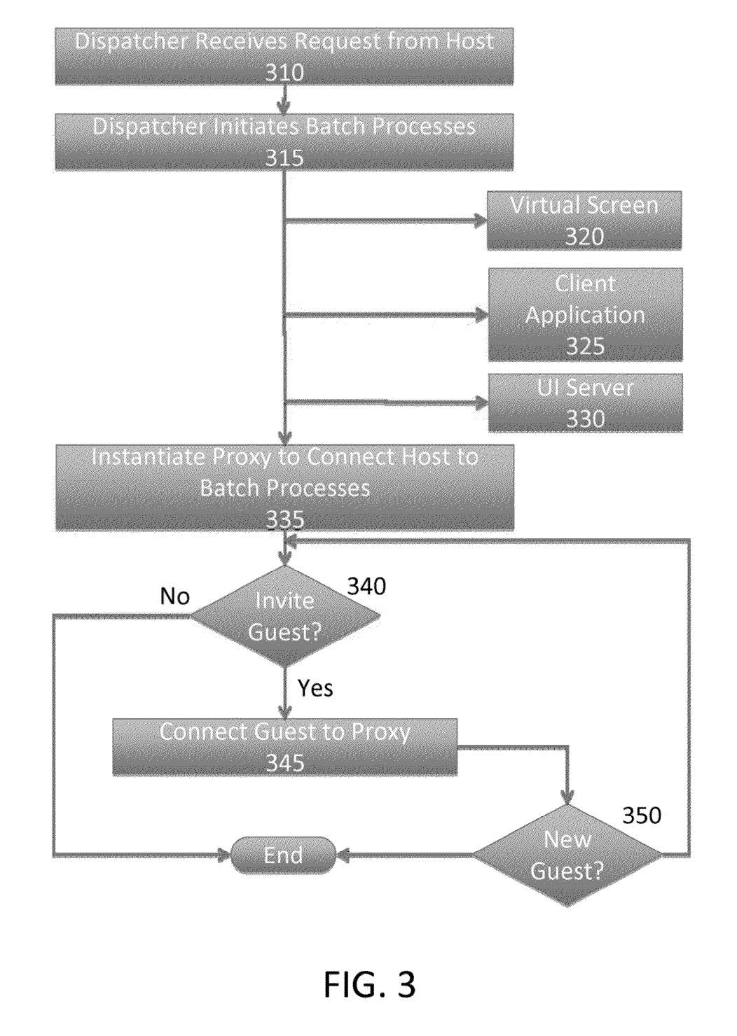

FIG. 3 is a flow diagram illustrating one embodiment to initiate a session among multiple users to co-use a software application. In some embodiments, the system designates a host to initiate the co-use session with the application software. Then, the host invites one or more guests to “co-use” the resources of the software application. The process begins as the dispatcher receives a request from a host to initiate a session with the application (block 310, FIG. 3). In response to the request, the dispatcher initiates the batch processes (block 315, FIG. 3) to instantiate the virtual screen (320), client application (325) and UI server (330). Then, a proxy, which connects the host to the batch processes, is instantiated. The host may then invite one or more guests, and the guests are connected to the proxy (which connects the guests to the batch process services) (blocks 340 and 345, FIG. 3). If the host desires to add a new guest, then the process is repeated and subsequently the new user is connected to the proxy so as to gain access to the batch process services (blocks 350, 340 and 345, FIG. 3). If all guests have been connected to the batch process service, then the initialization is complete.

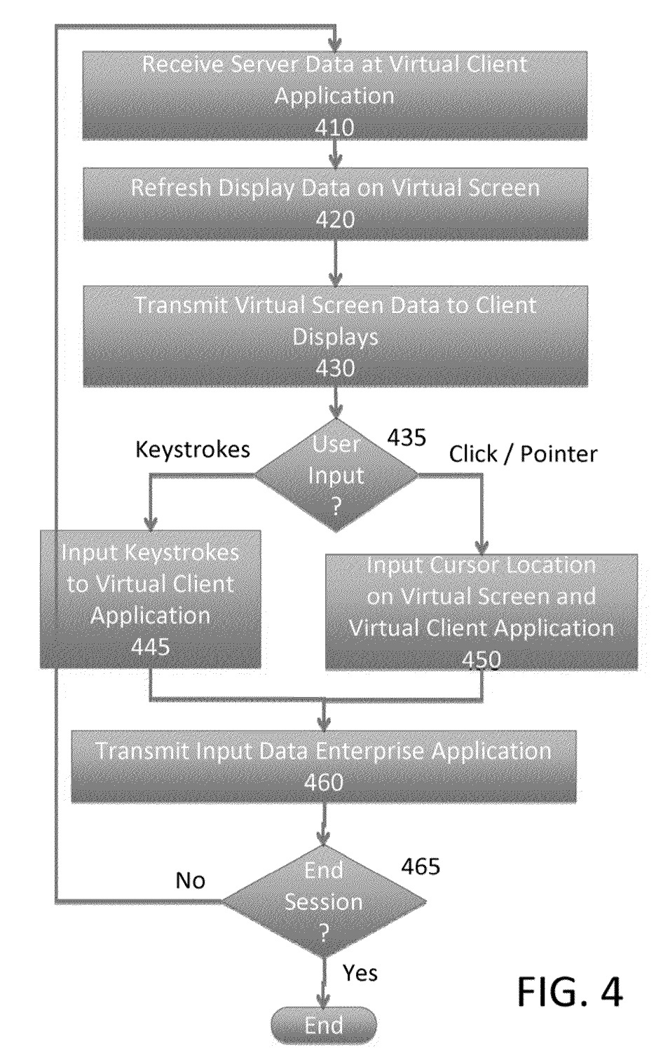

FIG. 4 is a flow diagram illustrating one embodiment for a process for multiple users to co-use an application program. As described above, the application may run on one or more remote servers, and the virtual client application forms a client-server environment with the application and database server(s). For this embodiment, the process begins when the virtual client application, running on the virtual server, receives data from the application. For example, the application may comprise a login screen to facilitate a user, such as the host, to log-on to the application. In response to receiving the data at the virtual application, the display data is refreshed on the virtual screen (block 420, FIG. 4). For example, if the application transmits a logon screen, then a rendition of the logon screen is rendered on the virtual screen on the virtual server. The updated virtual screen data is then transmitted to the user computers for rendering on the various client displays. For example, if one user computer consists of a mobile device, then the application logon screen is rendered on the display of the mobile device. Similarly, if the user computer device consists of a desktop computer, with a high-resolution output display, the logon screen for the application software is rendered on the high-resolution output display. Then, the process waits for input from the user computers (block 435, FIG. 4). If the system server receives, from one or more user computers, keystrokes, then the keystrokes are input to the virtual client application (block 445, FIG. 4). If the user computer inputs a click, along with cursor position information, then the input cursor location and click are updated on the virtual screen and input to the virtual client application (blocks 435 and 450, FIG. 4). In one embodiment, the UI server monitors keystroke, click and cursor position from the user computers to perform these functions. The input data (keystroke, click and cursor position) from the user computers is transmitted to the application from the virtual client application (block for 60, FIG. 4). This process, which includes receiving data from the application, transmitting screen data to the user computers, receiving input data from the user computers, and subsequently inputting data to the application, is repeated until users desire to end the session with the application.

The application co-use techniques disclosed herein support use cases for training and service of applications software. For example, a host may co-use an application to train a guest in learning to use the application. Under this use case scenario, a host may conduct transactions with the application through the virtual server. Then, a guest may interact with the application software without requiring the host to relinquish control to the guest. In contrast, in a screen sharing application, the host computer transfers control to the guest computer in order to permit the guest computer to conduct transactions with the application. As such, the application co-use techniques disclosed herein support co-using applications between users without requiring transfer of control or host screens. The application co-use techniques disclosed herein support use cases that effectively require switching control between users such that both co-users input data to the application. As such, application co-use techniques disclosed herein provide an environment for true collaboration because users are not required to execute functions in order to transfer the ability for each co-user to input data into the application.

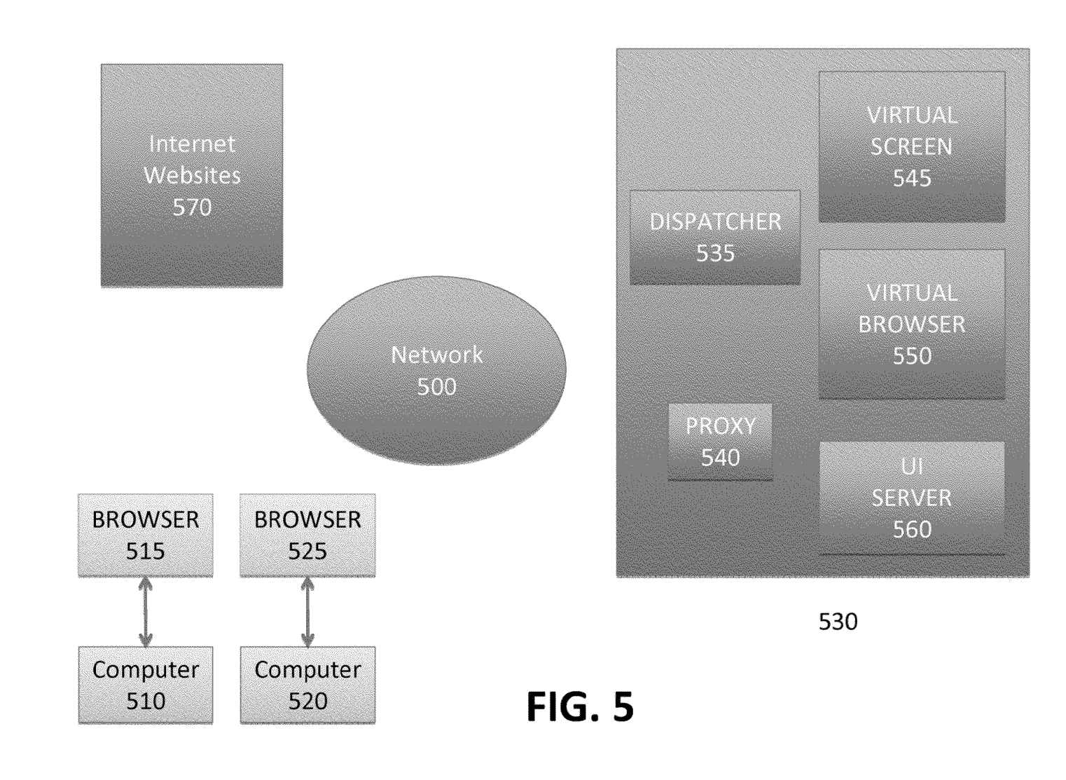

FIG. 5 is a block diagram illustrating one embodiment for implementing Internet co-browsing among multiple users. To conduct a co-browsing session, users, from computers 510 and 520, operating through their respective browsers (515 and 525), access a virtual browser 550 on virtual server 530 via network 500. The virtual browser 550 operates to access Internet websites 570 through network 500. The virtual screen 545 stores screen data for replication to computers 510 and 520. UI server 560 monitors incoming data from browsers (515 and 525) of computers (510 and 520) and inputs the incoming data to virtual screen 545 and UI server 560. The dispatcher 535 receives requests to begin Web browsing sessions and, in turn, initiates, as a batch process, the virtual screen 545, virtual browser 550 and UI server 560 processes. After a session has been started, computers 510 and 520 access the batch processes through proxy 540.

In operation, users, through computers 510 and 520, access Websites (Internet websites 570). Users enter website information into their respective browsers (515 and 525). This website information is input to the virtual browser 550. Virtual browser 550, operating like browser 515 and 525, accesses the Internet websites through a standard HTTP TCP/IP protocol. Virtual browser 550 transmits the website information, input by the users, to the Internet websites 570, and retrieves website response data returned by the Website. The response data is transferred to the virtual screen 545, and subsequently transmitted to computers 510 and 512, through browsers, for display at computers 510 and 512.

As the sessions are co-browsing, any user (user of computer 510 or user computer 520) may input information (keystrokes, clicks and cursor position), and the input information is both displayed on the virtual screen and interpreted for a web request to the Internet websites 570. In some embodiments, the co-browsing session designates a host and one or more guests. For this embodiment, the host may initiate a co-browsing session with one or more guests.

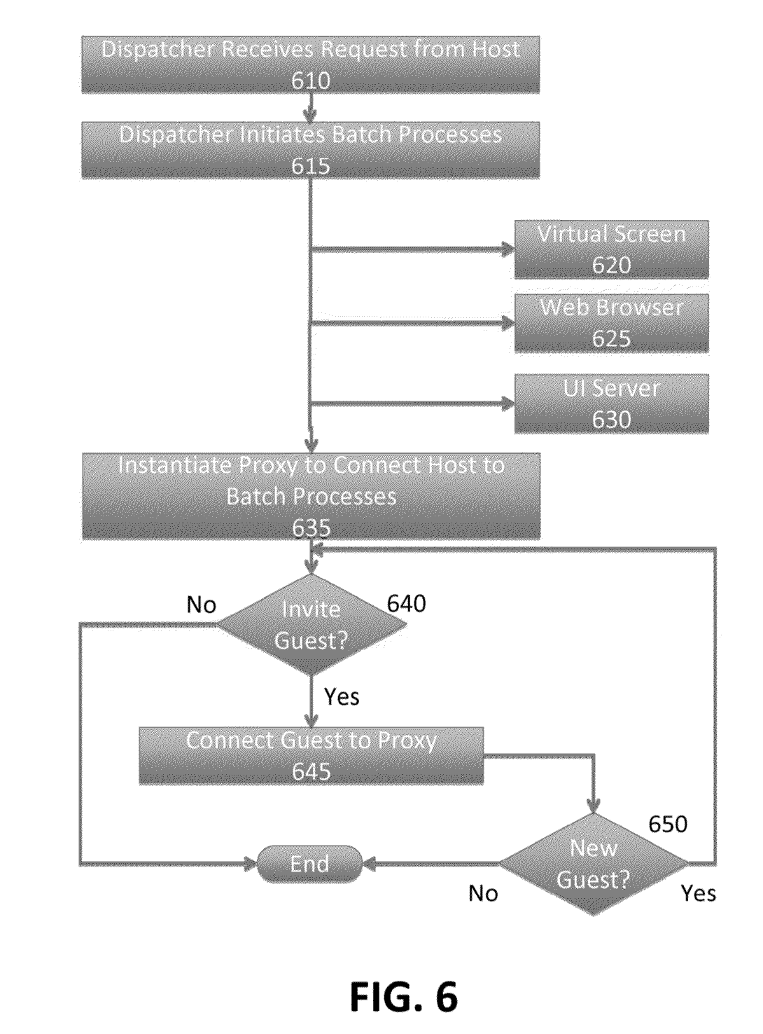

FIG. 6 is a flow diagram illustrating one embodiment for initiating a co-browsing session. The dispatcher receives a request from a host to initiate a web browsing session (block 610, FIG. 6). In response to the request, the dispatcher initiates batch processes (block 615, FIG. 6) that include virtual screen (block 620), virtual web browser (block 625) and UI server (block 630). Then, a proxy is instantiated to connect the host computer to the initiated batch processes (block 635). The host user is now connected for a web browsing session. To add one or more guests, the host, in some predetermined protocol, may invite a guest (block 640, FIG. 6). To add a guest, the guest connects to the batch processes via a proxy. Similarly, additional guests for the co-browsing session may be entered (block 650, 640 and 645, FIG. 6).

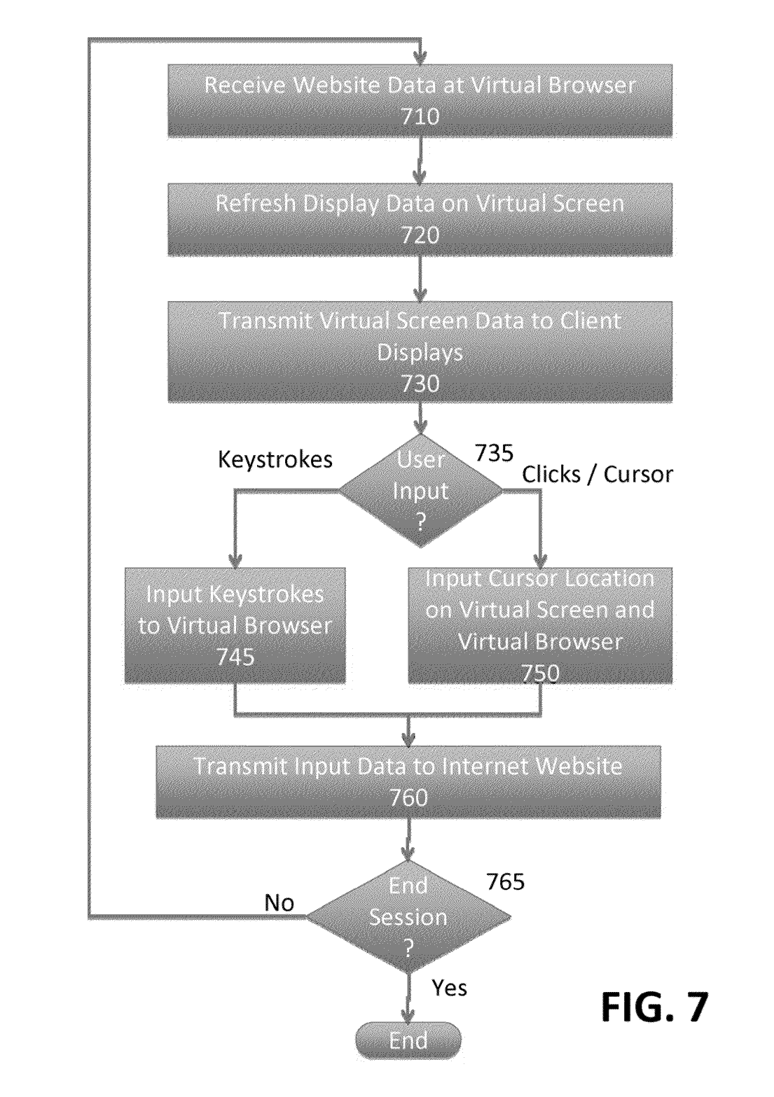

FIG. 7 is a flow diagram illustrating one embodiment for a co-browsing process. Initially, a user sends web information to access a Website of interest. The web information is received at the virtual browser (block 710, FIG. 7). The display screen on the virtual screen is refreshed (block 720, FIG. 7). The virtual screen data is transmitted, over the network, for display on the user computers. The requests, including the web information, output from the user computers, are monitored to detect a user operation (i.e., input keystroke, clicks, and cursor position). If the user inputs keystrokes, then the keystrokes are input to the virtual browser, as appropriate (block 745, FIG. 7). If the user inputs clicks and cursor position, the input cursor location is input to the virtual screen and the virtual browser (blocks 735 and 750, FIG. 7). In response to the input data, the virtual browser transmits the web information to Internet websites (block 760, FIG. 7). The steps for the user to request web information from the user device and subsequently retrieve response information from the virtual server and Internet websites are repeated for each request and response cycle (blocks 710, 720, 730, 735, 745, 750, 760).

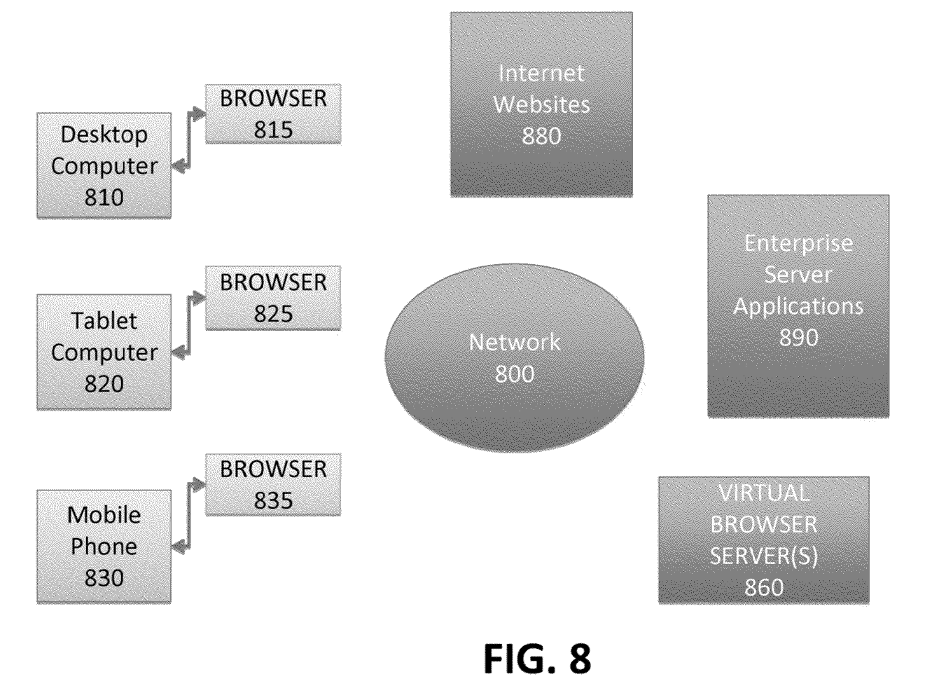

FIG. 8 is a block diagram illustrating a use case scenario for Internet co-browsing and co-using of applications. For this example, user computers include desktop computer 810, tablet computer 820 and mobile phone 830. Each computer device has different computing resources. For example, desktop computer 810 may have a 15-inch screen, tablet computer 820 may have an 8-inch screen while mobile device 830 has yet an even smaller display. For this use case, virtual browser server(s) 860 implement co-browsing for the different computer user devices. The screen data, rendered on the display of the different computing devices, originates from the virtual browser server (virtual screen). As such, the co-browsing session is not dependent on a format of any computing device of a user (e.g., desktop computer 810, tablet computer 820 or mobile phone 830). In this way, a mobile device 830 may host a web co-browsing session and the screen data from the mobile device, although originates from a small screen area, is translated to an environment appropriate for the larger desktop computer display.

A user of the mobile phone may resize the website response information to view it in a manner appropriate for a mobile device. Since both the desktop computer and a mobile computer see the data of the virtual screen, the mobile phone may resize a portion of the website response information without affecting the size and view of the Website information displayed on the desktop computer. The co-browsing sessions are also not affected by the means at which data is input to the computing devices. For example, a user may click on an image or link using a finger for a tablet computer or mobile device, and click on a link or image through a cursor control device (mouse, electrostatic pad). The input means does not affect co-browsing on the other computing devices. Also, user computer devices may include plug-ins to execute processes and services particularly suitable for the native device. The plug-ins, which enhance the user experience based on the type of computing device, do not affect data seen on other co-browsing user devices. As such, co-browsing is implemented among computers with disparate resources, including different screen sizes, input means and browser configurations.

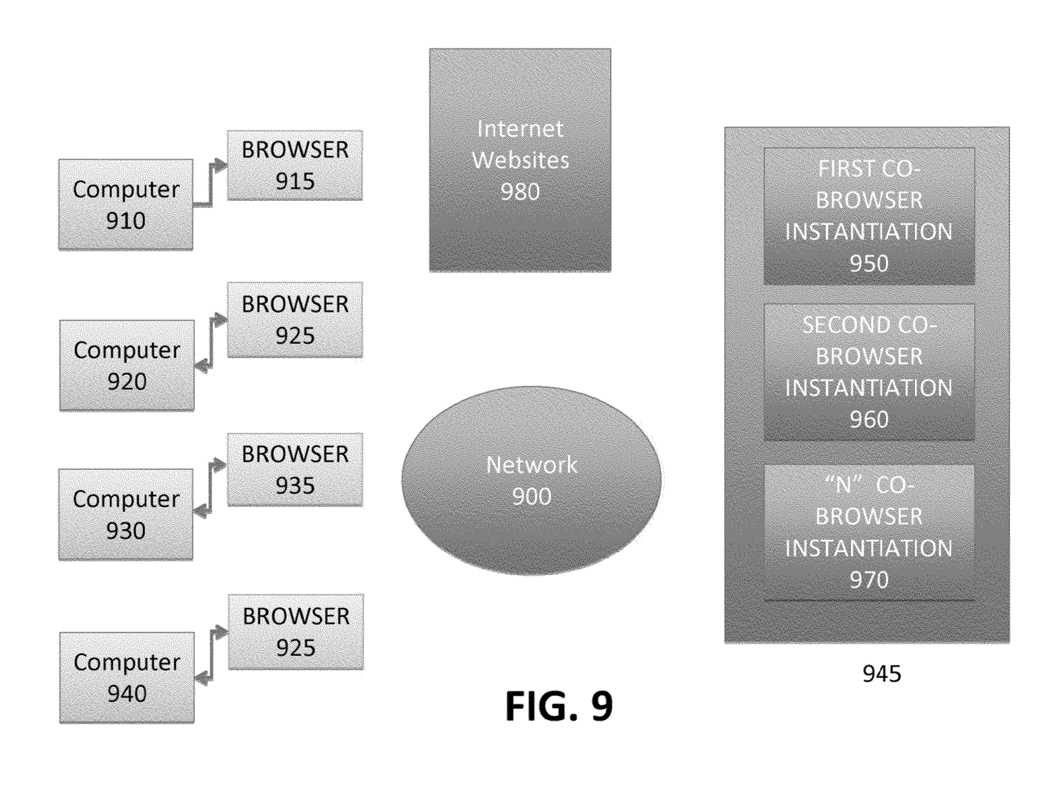

FIG. 9 is a block diagram illustrating co-browsing with multiple co-browser instantiations at the virtual server. As shown in FIG. 9, virtual server 945 supports multiple co-browsing sessions simultaneously. In this way, any user on a computing device (computer 910, 920, 930 and 940) may enter into one or more co-browsing sessions with another user. For example, computer 910, through browser 915, may enter into a first co-browsing session with user of computer 920. In the first co-browsing session, data is generated (i.e., cookie data collected from websites visited). Co-browsing data for the first co-browsing session may be stored in the first co-browser instantiation 950. A second co-browsing session, supported by a second co-browser instantiation 960, may include a browsing session with computers 930 and 940. Similarly, any combination of any user computers may enter into a co-browsing session to create any number of “N” co-browsing sessions. For example, computer 910, although in a co-browsing session with computer 920, may enter into a couple browsing session with computer 930 or 940.

Typically, in a co-browsing session, cookies are shared among the computers co-browsing. In the co-browsing techniques disclosed herein, session data (cookies) are not shared. All session data remains at the virtual server (on the virtual browser). As such, the co-browsing techniques disclosed herein provide a secure co-browsing environment for the user computers.

The co-browsing techniques disclosed herein support saving and securing session data for different sessions. In one use case, a host may wish to start several different sessions with different users. For sample, a host of a virtual shopping experience may start a co-browsing session with multiple users. For the example configuration shown in FIG. 9, the host user may use computer 910 and browser 915. The guest users, in this example, may use computers 920, 930 and 940. The host computer 910 may co-browse with computer users 920, 930 and 940, to create session data in the first co-browser instantiation (950). Then, the host user (computer 910) may desire to create a second co-browser instantiation 960 to conduct a one-on-one session between host computer 910 and guest computer 920. During co-browsing in this second co-browsing session, all session data is stored within the second co-browser instantiation 960. In this matter, any number of sessions may be created and the co-browsing data, collected during the session, may be secured and stored. It this way, a co-browsing session may be continued in the future by using session data from a prior co-browsing session.

The co-browsing architecture disclosed herein supports the ability to co-browse among all Internet websites. Using these embodiments, websites do not require special Java enabled scripts for execution in a user computer browser. One application for co-browsing is the creation of a virtual party with multiple browsers. In one use case, a host may provide a shopping experience for one or more guests. The host may want to navigate to different websites and present different products and services to the guests. Using the co-browsing techniques described herein, the host may shop at any retailer website without restriction to only shopping at co-browser enabled websites. Similarly, a co-browsing session may be used to plan travel among one or more friends arranging a trip. Again, the co-browsing users may navigate to any website without restrictions as to whether the website is browser enabled. Since the co-browsing session to organize a trip would potentially include many different types of websites (e.g., websites for transportation, hotels, entertainment, etc.), the co-browsing techniques described herein support use cases where the co-browsing session includes many different types of websites.

### Computer & Network System

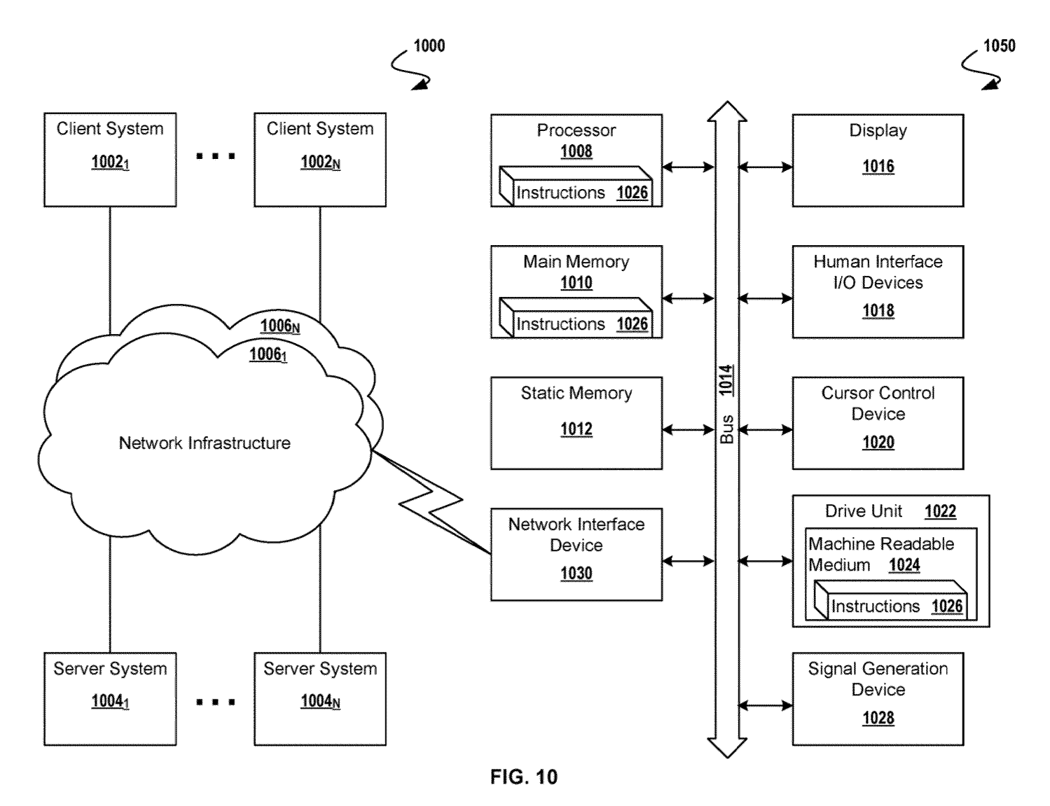

FIG. 10 is a diagrammatic representation of a network 1000, including nodes for client computer systems 1002₁ through 1002_{N}, nodes for server computer systems 1004₁ through 1004_{N}, nodes for network infrastructure 1006₁ through 1006_{N}, any of which nodes may comprise a machine 1050 within which a set of instructions for causing the machine to perform any one of the techniques discussed above may be executed. The embodiment shown is purely exemplary, and might be implemented in the context of one or more of the figures herein.

Any node of the network 1000 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g. a combination of a DSP and a microprocessor, a plurality of microprocessors, one or more microprocessors in conjunction with a DSP core, or any other such configuration, etc.).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g. a client computer system, a server computer system) and/or may comprise one or more embedded computer systems, a massively parallel computer system, and/or a cloud computer system.

The computer system 1050 includes a processor 1008 (e.g. a processor core, a microprocessor, a computing device, etc.), a main memory 1010 and a static memory 1012, which communicate with each other via a bus 1014. The machine 1050 may further include a display unit 1016 that may comprise a touch-screen, or a liquid crystal display (LCD), or a light emitting diode (LED) display, or a cathode ray tube (CRT). As shown, the computer system 1050 also includes a human input/output (I/O) device 1018 (e.g. a keyboard, an alphanumeric keypad, etc.), a pointing device 1020 (e.g. a mouse, a touch screen, etc.), a drive unit 1022 (e.g. a disk drive unit, a CD/DVD drive, a tangible computer readable removable media drive, an SSD storage device, etc.), a signal generation device 1028 (e.g. a speaker, an audio output, etc.), and a network interface device 1030 (e.g. an Ethernet interface, a wired network interface, a wireless network interface, a propagated signal interface, etc.).

The drive unit 1022 includes a machine-readable medium 1024 on which is stored a set of instructions (i.e. software, firmware, middleware, etc.) 1026 embodying any one, or all, of the methodologies described above. The set of instructions 1026 is also shown to reside, completely or at least partially, within the main memory 1010 and/or within the processor 1008. The set of instructions 1026 may further be transmitted or received via the network interface device 1030 over the network bus 1014.

It is to be understood that embodiments of this invention may be used as, or to support, a set of instructions executed upon some form of processing core (such as the CPU of a computer) or otherwise implemented or realized upon or within a machine- or computer-readable medium. A machine-readable medium includes any mechanism for storing information in a form readable by a machine (e.g. a computer). For example, a machine-readable medium includes read-only memory (ROM); random access memory (RAM); magnetic disk storage media; optical storage media; flash memory devices; electrical, optical or acoustical or any other type of media suitable for storing information.

Although the present invention has been described in terms of specific exemplary embodiments, it will be appreciated that various modifications and alterations might be made by those skilled in the art without departing from the spirit and scope of the invention.

What is claimed is:

1. A computer-implemented method for sharing remote computer resources, comprising:
instantiating, on at least one server, comprising at least one processor and memory, an application program so as to run a virtual application on the server;
coupling, via a network, at least one computer device for communications with the server;
instantiating, on the server, a virtual screen for storing screen data corresponding to an input data from the computer device and an output data from the virtual application; and
instantiating, on the server, a UI server for receiving the input data from the computer device for input to the virtual application and for transmitting screen data from the virtual screen to the computer device,
whereby the computer device utilizes the application running on the server.

2. The computer-implemented method as set forth in claim 1, wherein the at least one computer device comprises a mobile computing device.

3. The computer-implemented method as set forth in claim 1, wherein the at least one computer device comprises a plurality of computer devices.

4. The computer-implemented method as set forth in claim 3, wherein the input data comprises a first input data comprising keystrokes, clicks and cursor position from a first computer device and a second input data comprising keystrokes, clicks and cursor positions from the second computer device.

5. The computer-implemented method as set forth in claim 4, wherein:
receiving, at the UI server, from a first computer device, the first input data comprises receiving the first input data from the first computer device as a host of a co-use application session; and
receiving, at the UI server, from the second computer device, the second input data comprises receiving the second input data from the second computer device as a guest of the co-use application session.

6. A computer-implemented method for co-browsing one or more websites between at least two users, comprising:
instantiating, on at least one server, a virtual browser to interact with a plurality of websites;
receiving, at the virtual browser, from a first computer device, a first input data that specifies a request to enter a session at one of the websites;
receiving, at the virtual browser on the server, from a second computer device, a second input data for the session at the Website;
generating, from the virtual browser, one or more requests to the website based on the first and second input data;
receiving, at the virtual browser, in response to the request to the website, response data from the website; and
transmitting, from the server to the first and second computer devices, the response data from the website.

7. The computer-implemented method as set forth in claim 6, further comprising:
instantiating, on the first computer device, a first computer device browser;
instantiating, on the second computer device, a second computer device browser;
generating the first input data from the first computer device browser;
generating the second input data from the second computer device browser;
rendering, via the first computer device browser, the response data on the first computer device; and
rendering, via the second computer device browser, the response data on the second computer device.

8. The computer-implemented method as set forth in claim 6, wherein at least one of the first computer device or the second computer device comprises a mobile computing device.

9. The computer-implemented method as set forth in claim 6, wherein the first input data comprises keystrokes and clicks from the first computer device and the second input data comprises keystrokes and clicks from the second computer device.

10. The computer-implemented method as set forth in claim 6, wherein:
receiving, at the virtual browser, from the first computer device, the first input data comprises receiving the first input data from the first computer device as a host of a co-browsing session; and
receiving, at the virtual browser, from the second computer device, the second input data comprises receiving the second input data from the second computer device as a guest of the co-browsing session.

11. The computer-implemented method as set forth in claim 6, further comprising:
receiving the first input data from the first computer device as a host of a co-browsing session;
receiving the second input data from the second computer device as a first guest of the co-browsing session;
receiving a third input data from a third computer device as a second guest of the co-browsing session;
instantiating a first set of session data based on co-browsing activity between the first computer device as a host and the second computer device as the first guest; and
instantiating a second set of session data based on co-browsing activity between the first computer device as a host and the third computer device as the second guest.

12. A computer readable medium comprising a plurality of instructions, which when executed by a computer, causes the computer to implement co-browsing one or more websites between at least two users, the instructions for:
instantiating, on at least one server, a virtual browser to interact with a plurality of websites;
receiving, at the virtual browser, from a first computer device, a first input data that specifies a request to enter a session at one of the websites;
receiving, at the virtual browser on the server, from a second computer device, a second input data for the session at the Website;
generating, from the virtual browser, one or more requests to the website based on the first and second input data;
receiving, at the virtual browser, in response to the request to the website, response data from the website; and
transmitting, from the server to the first and second computer devices, the response data from the website.

13. The computer readable medium as set forth in claim 12, further comprising:
instantiating, on the first computer device, a first computer device browser;
instantiating, on the second computer device, a second computer device browser;
generating the first input data from the first computer device browser;
generating the second input data from the second computer device browser;
rendering, via the first computer device browser, the response data on the first computer device; and
rendering, via the second computer device browser, the response data on the second computer device.

14. The computer readable medium as set forth in claim 12, wherein at least one of the first computer device or the second computer device comprises a mobile computing device.

15. The computer readable medium as set forth in claim 12, wherein the first input data comprises keystrokes and clicks from the first computer device and the second input data comprises keystrokes and clicks from the second computer device.

16. The computer readable medium as set forth in claim 12, wherein:
receiving, at the virtual browser, from the first computer device, the first input data comprises receiving the first input data from the first computer device as a host of a co-browsing session; and
receiving, at the virtual browser, from the second computer device, the second input data comprises receiving the second input data from the second computer device as a guest of the co-browsing session.

17. The computer readable medium as set forth in claim 12, further comprising:
receiving the first input data from the first computer device as a host of a co-browsing session;
receiving the second input data from the second computer device as a first guest of the co-browsing session;
receiving a third input data from a third computer device as a second guest of the co-browsing session;
instantiating a first set of session data based on co-browsing activity between the first computer device as a host and the second computer device as the first guest; and
instantiating a second set of session data based on co-browsing activity between the first computer device as a host and the third computer device as the second guest.
